(19) United States
(12) Patent Application Publication
(10) Pub. No.: US 2003/0046237 A1
(43) Pub. Date: Mar. 6, 2003

(54) Method and system for enabling the issuance of biometrically secured online credit or other online payment transactions without tokens

(76) Inventor: James Uberti, Marina del Rey, CA (US)

Correspondence Address: CHRISTIE, PARKER & HALE, LLP, P.O. BOX 7068, PASADENA, CA, 91109-7068, US

(21) Appl. No.: 10/280,732

(22) Filed: Oct. 24, 2002

Related U.S. Application Data
(63) Continuation-in-part of application No. 09/846,927, filed on Apr. 30, 2001.
(60) Provisional application No. 60/203,041, filed on May 9, 2000.

(51) Int. Cl. G06F 17/60

(52) U.S. Cl. 705/44

(57) ABSTRACT

A method and apparatus for issuance of biometrically secured online credit or other payment transactions without tokens or cards. A buyer supplies a registration biometric sample which is used to generate a registration biometric template. The registration biometric template is stored and used to authenticate financial transactions. As part of a registration process, a buyer may be verified using a series of questions generated from public and non-public information to which the buyer knows the answer but an impersonator may not. In subsequent financial transactions, the buyer supplies a verification biometric sample used to generate a verification biometric template. The verification and registration biometric templates are compared to determine if a requested financial transaction should be authorized. The kinds of biometric samples used may be keystroke-scans, face-scans, voice-scans, or fingerprint-scans. The comparison process between the verification biometric template and registration biometric template may be modified to reflect the value of a requested financial transaction. In addition, the verification biometric templates may include a time stamp to preclude reuse of a previously submitted biometric template and a system identifier to preclude submission of biometric templates from unauthorized systems.

### CROSS-REFERENCE TO RELATED APPLICATION

The present application is a continuation in part of co-pending U.S. patent application Ser. No. 09/846,927 filed Apr. 30, 2001 which claims priority of U.S. Provisional Patent Application No. 60/203,041 filed May 9, 2000.

### BACKGROUND OF THE INVENTION

This invention relates to the field of biometric verification technologies and more particularly to online biometric verification over a network.

Internet commerce has grown astronomically over the last few years. The Internet has grown, but so to have concerns about the possible abuse, privacy issues, and lack of security when completing payment transactions over the Internet. In addition, for buyers who regularly make web-based purchases, the need to continually fill out the same types of information, including credit card, delivery and billing information, across different web sites becomes tedious and time consuming. The open network of the Internet also heightens the possibility that this confidential information can be illicitly obtained by personnel at the merchant's web site, or by others who may hack into the merchant databases. Of similar concern is the possibility that a buyer's credit card information has been wrongfully obtained, and an unauthorized buyer is using the stolen credit card to make purchases and have these purchases shipped to an address other than the credit card owner's home or office. Encryption, by itself, does not adequately address these problems.

Merchants offering their goods and services over the Internet have dealt with security concerns in a variety of ways. For example, various encryption schemes are presently used to enhance Internet-based transactions, and are intended to encrypt the buyer's credit card number and the credit card's expiration date, and possibly other ordering information such as the buyer's mailing and billing addresses. One common concern expressed by buyers conducting transactions on the Internet is that while some merchants purport to offer a high level of security for web-based transactions, in practice many web merchants do not actually take adequate precautions to guard the buyer's credit card and other confidential information on merchant databases. Particularly when dealing with smaller and lesser-known merchants, buyers may, for good reason, not be willing to give private information over the Internet. To allay these concerns, some large Internet merchants offer buyers the option to call in and/or fax in credit card information. These additional, non-web based steps require additional human involvement and intervention, and therefore can interrupt an otherwise automated ordering and verification process. Side effects of this manual process include the potential for human error and additional transaction costs.

In another approach, single use or limited use disposable credit card numbers are generated and used for a limited number of transactions. These online disposable card numbers are difficult to use, and can only be completed by modified payment processes.

In another online approach, a pin number is required and associated with a registered merchant site at time of purchase in order to reduce fraudulent transactions. This approach requires the registered buyer to have to remember a PIN and or remember a pass phase and can only safeguard the payment transaction if used at a pre-registered merchant's website. The buyer must also sign up for this service, which increases the steps that are necessary for a buyer to purchase online. The card issuer must also be involved in the equation, so that they can control the online authorization of a verified buyer. The entire process is complex and more secure, however the buyer's inconvenience increases and the credit card number is still vulnerable in that it can be utilized at other merchants that accept credit cards, but who do not participate in the system.

In cases where unauthorized credit card transactions take place, it is usually the merchant (that has likely already shipped the goods to the unauthorized party), which bears the loss. This loss includes not only the cost of the goods, but also damage to the merchant's reputation as a secure place to shop.

Another shortcoming of web-based commerce is the tedious and time-consuming re-entering of the same type of payment and shipping information necessitated by the buyer. Therefore, a need exists for a private and secure identity authentication, enrollment and biometric verification system, which is portable to any e-commerce environment.

### SUMMARY OF THE INVENTION

In one embodiment of the invention, a method is provided for authorizing a financial transaction for a buyer over a computer network. A client process hosted by the buyer's computer system receives a verification biometric sample from the buyer. The client generates a verification biometric template using the verification biometric sample transmits the verification biometric template to a server through the computer network. The server generates a match score between the verification biometric template and an enrollment biometric template by the server and authorizes the financial transaction if the match score exceeds a threshold score.

In another embodiment of the invention, the client receives a transaction value from the buyer and transmits the transaction value to the server through the computer network along with the verification biometric template. The server generates the threshold score using the transaction value.

In another embodiment of the invention, a time, such as a time stamp, is associated with the verification biometric template and authorizing the financial transaction further includes using the time stamp.

In another embodiment of the invention, a system identifier is associated with the verification biometric template by the client an authorizing the financial transaction further includes using the system identifier.

In another embodiment of the invention, a credit account identifier is transmitted by the server back to the client through the computer network upon the server authorizing the financial transaction.

In another aspect of the invention, the biometric sample may be a facial-scan, a finger-scan, a hand-scan, an iris-scan, a keystroke-scan, a signature-scan, a voice-scan, a DNA-scan or a retina-scan.

In another aspect of the invention, the client may be hosted by a laptop computer, a desktop computer, a mobile telephone, or a personal digital assistant.

In one embodiment of the invention, a method is provided for opening a biometrically protected credit account by an applicant for use in a payment system over a computer network. A server receives an applicant identifier through the computer network from a client hosted by the buyer's computer system and generates a set of questions using the applicant identifier. The server transmits the set of questions to the client through the computer network to authenticate the identity of the online applicant. The applicant answers the set of identity questions and the server receives a set of answers corresponding to the set of questions from the client through the computer network and authorizes the credit account if the set of answers are correct with respect to the set of questions.

In another embodiment of the invention, a server receives an applicant identifier through the computer network from a client hosted by the buyer's computer system and generates a background query using several derogatory databases to confirm the identity of the applicant using applicant information included in the background check. The server uses a data verification process to measure the length of time the applicant's information has been in use while also scoring key identity elements for consistency such as: confirming a Social Security Number (SSN) given by the applicant corresponds with the applicant's address; confirming that the last name associated with the given SSN matches the last name given by the applicant; and assuring that the SSN does not belong to a decedent; and that the SSN given by the applicant SSN is unique. After the data verification process, the server authorizes the credit account if the data verification score is at a level that is acceptable.

In another embodiment of the invention, the client receives a biometric sample from the applicant and generates a biometric template using the biometric sample. The client transmits the biometric template by the client to the server through the computer network.

In another aspect of the invention, the biometric sample may be a facial-scan, a finger-scan, a hand-scan, an iris-scan, a keystroke-scan, a signature-scan, a voice-scan, a DNA-scan, or a retina-scan.

In another aspect of the invention, the client is hosted by a device selected from the group consisting of a laptop computer, a desktop computer, a mobile telephone, or a personal digital assistant.

In another aspect of the invention, a user interface is provided for a biometric shopping assistant used by a buyer to secure a financial transaction. The user interface includes a selectable icon for invoking the biometric shopping assistant; a biometric sample capture screen for capturing a biometric sample from a buyer by the biometric shopping assistant; and a transaction screen for display of biometric account information by the biometric shopping assistant.

In another embodiment of a user interface in accordance with the present invention, the biometric sample capture screen includes a prompt area for display of a prompt for the buyer by the biometric shopping assistant.

In another embodiment of a user interface in accordance with the present invention, the biometric sample capture screen includes selectable transaction values.

### BRIEF DESCRIPTION OF THE DRAWINGS

These and other features, aspects, and advantages of the present invention will become better understood with regard to the following description, appended claims, and accompanying drawings where:

FIG. 1 is a diagram illustrating a multi-tiered process for the enabling of the issuance of credit by utilizing a biometric system, including credit evaluation from an issuing bank, and identity validation by an third-party authentication provider, as well as the enrollment of at least one biometric sample facilitated by the biometric system, which then is tags the authenticated identity credential file with these biometric samples and stores this enriched identity credential at a biometric clearinghouse in the digital form of a biometric certificate, in accordance with an exemplary embodiment of the present invention;

FIG. 2 is a diagram depicting a verification process flow as a buyer uses the invention to make a biometrically secured credit transaction in accordance with an exemplary embodiment of the present invention;

FIG. 3 is a diagram showing the inter-relationship of certain functional and operative computer systems and components consisting of a biometric clearing house, an issuing bank, a detection server, a merchant bank, and the payment networks in accordance with an exemplary embodiment of the present invention;

FIG. 4 is a depiction of a Web browser display with a biometric shopping assistant icon in accordance with an exemplary embodiment of the present invention;

FIG. 5 is a depiction of a biometric shopping assistant graphical user interface in accordance with an exemplary embodiment of the present invention; and

FIG. 6 is a depiction of a completed data entry form in accordance with an exemplary embodiment of the present invention.

### DETAILED DESCRIPTION

In one biometric system in accordance with an exemplary embodiment of the present invention, a buyer does not have to provide their biometric information to any merchant that the buyer does business with, which would in turn greatly decrease the risks of theft, loss, or having the buyer's biometric information sold. The biometric system works with any merchants web sites, and the biometric system would be based at financial institutions, credit bureaus and payment processors and can be integrated at each of these points of presence. No images or raw biometric data are stored at any point in the biometric system, either on a web client, web server, or at a biometric clearinghouse. Instead, biometric templates—files containing distinctive mathematical elements derived from the original biometric samples and transformed into digital binary code—are utilized. These templates are scrambled by the biometric system's unique algorithm before transport and unscrambled at the database by another unique algorithm for storage as a unique data file/biometric template for use in the biometric verification system. For instance, in the biometric system in accordance with an exemplary embodiment of the present invention, an applicant for biometric credit fills out a normal online application for credit and answers a set of random questions generated from regulated data from their credit profile or unregulated data from extensive public, proprietary, and private information databases to authenticate the applicant's identity in real-time and online. Once approved for credit, the system creates an identity credential file, and then assigns a unique account number that is encrypted and stored in the buyer's computer system. The biometric system ensures the credibility of the applicant by asking for a biometric enrollment template, and this biometrically created data is appended to the identity credential, thus creating a biometric certificate, which is an enriched identity credential file that future biometric templates can be matched to confirm identity in real-time, to allow for secure and recurring biometrically verified purchases for the online buyer. To complete online transactions, the buyer submits a live biometric sample including a biometric template that is transmitted to the detection server along with the unique account number, which is forwarded by a detection server to a clearinghouse for comparison with the biometric enrollment template. The unique account number would be associated with the biometric certificate, so as to facilitate 1:1 comparison at the biometric clearinghouse database when a live sample is submitted. This part of the invention is necessary to increase the speed and accuracy of the matching process within a database, because a 1:N (one to many) would require more computational power and thus more servers and more cost. When a match occurs between the stored biometric template and the submitted biometric template, the biometric system accesses the biometric certificate, and a verification of a buyer's identity occurs. The identity never has to be transmitted through the system, only verified at a secure location, so the consumer's privacy is protected. Verifications are returned to the detection server and routed to a separate and secure database, at which point the buyer's biometrically protected credit account number and expiration date, if required are retrieved. The date and time of the transaction as well as the maximum dollar amount allowed for the transaction are recorded in the detection server database. The date and time of the transaction coupled with the maximum allowed dollar amount for the transaction provides transaction information to verify the transaction. The biometrically protected credit account number and expiration date are passed to the merchant from the separate and secure database through the detection server, and the web transaction proceeds as normal. Merchants verify the financial institutions assigned credit account number and expiration date as submitted from the biometric system.

The biometrically protected credit account number and the expiration date represent a point of commonality between the biometric system and existing online payment infrastructure. A difference exists when the biometric system creates a Transaction Verification Certificate (TVC) based on an existing biometric credit account and expiration date along with a maximum dollar amount for the transaction. The transaction data also includes the buyer's unique account number, as well as the date and time the biometric verification was successful. The biometric system server sends all or part of this information to the credit issuer or processor where it is posted at their database or processing center database. This post is then compared to the transaction information when it arrives at the bank or processor. Without the post, the transmission is not considered to have been biometrically verified, so the transaction would be denied.

In slightly more detail, visitors to a financial institution's website powered by a biometric system in accordance with an exemplary embodiment of the present invention apply for a line of credit. Applicants for credit also go through an additional step of answering a series of randomly generated questions generated from the buyer's credit profile, public data, as well as private, and proprietary data, so as to prove their identity at time of an online credit application. Once approved by the financial institution, authenticated applicants are prompted to enroll their biometric information via any biometric device (i.e. voice-scan, finger-scan or keystroke-scan). After enrollment of a biometric identifier, the financial institution approves an amount of credit that is made available for immediate use to the applicant; now buyer, and forwards a biometrically protected credit number for storage within the biometric system at a separate and secure database. Buyers submit biometric identifier(s) to facilitate future online purchases. When prompted for payment information for future online purchases, buyers provide a live biometric sample. A biometric template is extracted on a local client from the buyer's live biometric sample, and transmitted along with a unique account number through a detection server to a biometric clearinghouse computer system for match scoring. If a match occurs, the template code accesses a stored biometric certificate to verify the identity of the individual proposing the transaction.

A successful verification results in a transaction origination. The biometrically protected credit number and expiration date, which are hosted by the biometric system in a separate and secure database, are supplied to the merchant's Web page and the transaction proceeds as normal. The merchants' payment gateway providers verify this credit account number and expiration date as submitted from the biometric system, and this information proceeds through the normal payment system without any modification.

In a biometric system in accordance with an exemplary embodiment of the present invention, the biometric system's biometric credit verification is based on finger-scan biometrics. In other biometric systems in accordance with exemplary embodiments of the present invention, other biometric technologies are used such as such as facial-scans, iris-scan, retinal-scans, voice-scans, and keystroke-scans.

In a biometric system in accordance with an exemplary embodiment of the present invention, buyers approved for credit after application processing and identity authentication are prompted to enroll via voice-scan or keystroke-scan technology. Enrollment of a biometric identifier(s) grants immediate access to the buyer's authorized credit line. A finger-scan device is shipped to the buyer; after enrollment of the buyer's finger-scan information, the remaining credit line is made available for subsequent transactions. If no biometric identifier is enrolled, then credit issuance would not occur until the finger-scan device was activated and enrolled with the biometric system.

In the biometric system in accordance with an exemplary embodiment of the present invention, buyers are presented with a brief tutorial on device usage demonstrating enrollment procedures for voice and keystroke-scan. Pre-enrollment screens prompt buyers to speak their pass phrase or type a password to ensure that the quality of the enrollment biometric sample is sufficient to generate a biometric template.

In a biometric system in accordance with an exemplary embodiment of the present invention, biometric templates rather than biometric samples are used to verify a buyer. The use of biometric templates makes it extremely difficult to recreate a buyer's original biometric information, thus providing protection against misuse of biometric data. From a security perspective, a buyer's biometric template is not static. A unique template is derived from each biometric sample collected by the biometric system at time of verification. As each biometric template is unique, it is difficult to use a buyer's biometric template to track a buyer's purchases across multiple systems.

In a biometric system in accordance with an exemplary embodiment of the present invention, the biometric matching, biometric certificate verification, and post-match transmission components of the biometric system are separate. The former relates directly to comparison of biometric information, verification relates to real-time identity validation, while the latter describes the result of a biometric decision.

However, from the customer perspective, the match and these results are part of the same process. The user experience is that submission of a biometric sample will be followed within a few seconds with a match, verification, and an authorized transaction.

In a biometric system in accordance with an exemplary embodiment of the present invention, a biometric verification interface is used at the time of purchase, when a buyer is prompted to enter payment information. This biometric interface icon is the front end of the detection server and resides at the buyer's computer system, which is responsible for gathering data to be matched at the biometric clearinghouse, which are separated on a different private network that connect to the template database servers.

The buyer provides a live sample in order to be verified biometrically. This information is used to generate a unique identifier as well as a unique account number that is stored locally by the buyer's web client. This identifying information will accompany the biometric template transmitted for matching. Matches then generate the final identity verification.

Simultaneously with buyer identification, the biometric verification interface can automatically detect the payment interface on the e-commerce site. This is to provide a destination for the individual's biometrically protected credit account number and expiration date after the biometric match.

Assuming that the live biometric sample is verified successfully, a separate and secure database is used to retrieve the biometrically protected credit number and expiration date, as well as records the date and time of the transaction along with a maximum transaction dollar amount for this specific transaction. This is routed back to the merchant interface, at which point the transaction proceeds as normal. From the customer's perspective, the purchase is made without having to type in or needing to know a credit card number and expiration date; from the merchant's perspective, a transaction has occurred which can be verified through standard processes; and from the Company and partner bank's perspective, the identity of the customer has been verified, resulting in retrieval of the biometrically protected credit account number and expiration date as well as recording the date and time of the transaction along with a maximum transaction dollar amount for a specific transaction, and formulation of the data to be posted in a Transaction Verification Certificate (TVC).

Once the identity of a buyer has been verified, the authorization server retrieves the biometrically protected credit account number and expiration date that can be utilized by existing credit card processing systems thus allowing the biometric system to gain access to existing legacy payment systems. The buyer is then able to use credit at any Internet merchant capable of processing VISA or MasterCard (American Express and Discover have their own gateways and proprietary networks) or other credit card transactions, opening the online credit market to an online biometric credit issuing financial services company.

In another biometric system in accordance with an exemplary embodiment of the present invention, the biometric system provides value by enabling trusted transactions. To do so, the biometric system interacts with existing technology and interfaces at the client and merchant levels. The biometric system interacts with external, non-biometric systems and processes at several points, as described below.

Most buyer's first biometric experience takes place at a biometric enrollment website or a financial institution's website. Biometric credit services integrate into existing e-commerce platforms, while the back-end verification and data storage components are capable of migrating to newer platforms.

In another biometric system in accordance with an exemplary embodiment of the present invention, a number of procedural protections are in place to provide consistent, secure, and reliable system operation for customers and merchants.

Though most buyers will use the same finger for most of their transactions, enrolling a second finger results in a redundant biometric sample source in case of cuts or changes in skin condition.

Depending on the biometric peripherals deployed, templates can be generated either on the device or on the local PC or PDA. For applications in which security is an extremely important factor, creation of the template on the device eliminates the very slight possibility that sensitive information might be captured in transit from the local PC. These “trusted” devices could also incorporate data/time stamp into a biometric transmission. However, this is a more expensive solution, as more processing power needs to be built into the peripheral.

There will be situations in which data residing in the matching database will need to be updated, such as in cases of re-enrollment of the same or different fingers. The movement of data will follow the same basic procedures outlined above. Templates are generated locally, either by a buyer's web client or on a peripheral device, and are transmitted in encrypted fashion through the biometric company website to the biometric clearinghouse. Depending on the technology partners involved, a buyer may need to authenticate their identity or re-verify against their enrolled biometric data as a precondition of updating any biometric information.

In another biometric system in accordance with an exemplary embodiment of the present invention, the biometric system checks incoming verification templates against hashes of the buyer's most recent verification templates in order to reduce the chances of a replay attack. A replay attack is an attempt to reuse an intercepted transmission from a web client to a web server in an effort to make unauthorized purchases. To counter this, the biometric system verifies that a biometric template has not been used in recent transactions, as two different biometric templates from the same buyer taken at different times do not generate the same hash value. In addition, the invention's dataflow protocol implements a hierarchical privilege level coupled with a time sensitive message exchange algorithm. These features provide that a single conversation cannot be replayed out of context or replayed outside the short lifespan of the conversation. If the first biometric verification attempts are unsuccessful, buyers have the option of verifying through additional biometric technologies such as voice-scan and keystroke scan. Nearly all buyers have microphones either as peripheral or embedded devices, so voice-scan is available to most buyers. Keystroke-scan, which measures typing patterns, is available to anyone using a PC that has a keyboard, and offers completely discreet strong authentication.

In another biometric system in accordance with an exemplary embodiment of the present invention, the biometric system communicates with one or more external computer systems in order to perform various functions, including determining if the buyer has sufficient credit resources, the debiting of a buyer's financial account, the crediting of the seller's financial account, or the construction of a credit authorization draft.

In another biometric system in accordance with an exemplary embodiment of the present invention, the biometric system includes a multi-tiered approach to biometric transaction verification. Variable Transaction Processing (VTP) reduces the risk of a false reject, which means rejecting a verified account holder, by decreasing the percentage needed to allow for a match for smaller dollar transactions, thus increasing the overall satisfaction and success of a biometrically verified transaction. For smaller purchases, the threshold for biometric verification (score match) is not as stringent, therefore allowing an increased likelihood of transaction acceptance. As purchase dollar amounts increase, the comparison(score match) between a submitted biometric template and a stored biometric template is placed under greater scrutiny to prevent false accepts and to increase the overall security of larger dollar purchases.

In another biometric system in accordance with an exemplary embodiment of the present invention, the biometric system is embodied in the concept of a biometric system aware web site, where the merchant integrates the biometric system software. A biometric system aware web site contains web pages including biometric system processing logic. Such web pages interact and communicate with the web client biometric system components to expand the online purchase processing logic.

When an online purchase originates from a biometric system aware web site, VTP processing is enhanced with an automated feature whereby the exact dollar amount of the purchase is provided by the web page logic. In such cases, the standard VTP transaction becomes an Automatic Variable Transaction Processing (AVTP) transaction. AVTP differs from a VTP transaction in that a merchant's web page processing logic interacts with the biometric system web client components to provide the exact dollar amount of the purchase. With AVTP, the buyer is freed from choosing a dollar range for the purchase and the purchase processing logic continues with the exact dollar amount of the purchase instead a dollar amount range for the purchase. As such, an AVTP transaction may provide for stronger verification since the exact dollar amount of the transaction is known as opposed to an acceptable dollar amount range for the transaction.

In another biometric system in accordance with an exemplary embodiment of the present invention, the biometric system a transaction arriving at a financial institution for final processing is directly related to a singular, biometrically secured originating transaction. In this regard, the biometric system may provide banking partners, and financial institutions the ability to certify and further assure that the authorized account holder made the transaction and further verify that the transaction is not a replay attack or a stolen identity.

This assurance is accomplished through the processing of the previously described TVC. A TVC provides for a unique set of transaction information to be pushed up to a financial institution's system ultimately responsible for performing the authorization processes for the transaction. The transaction information set is made available to the financial institution's system at the time the transaction is originated.

Providing the transaction information set to a financial institution system may be implemented by one of two approaches: (1) the financial institution alters their existing systems to listen for and accept the incoming transaction information from the biometric system or (2) the biometric system includes a biometric system gateway server connected by a private network to the financial institution's local network. The biometric system servers push the transaction information onto the biometric system gateway server. In turn, the financial institution's existing systems integrate directly to the biometric system gateway server and check for a TVC at established time intervals.

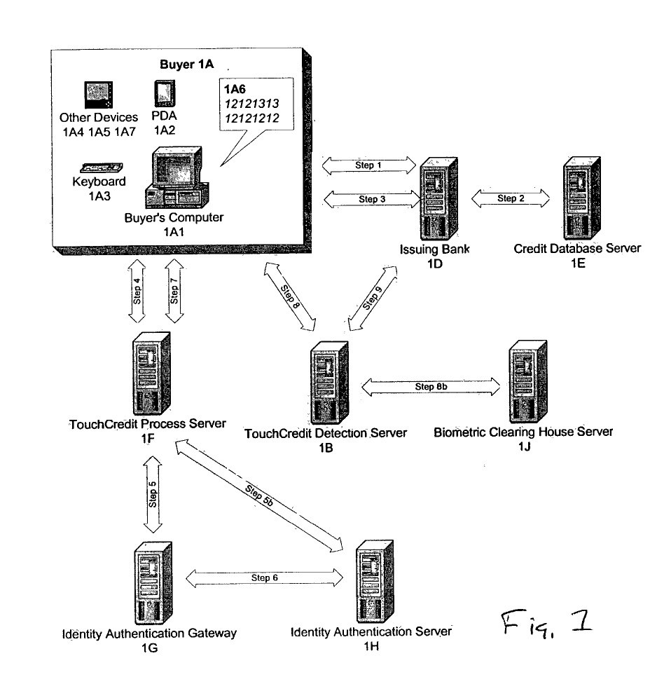

FIG. 1 is a diagram illustrating a process for the enabling of the issuance of credit by a biometric system, including credit evaluation from an issuing bank and the enrollment of at least one biometric sample, in accordance with an exemplary embodiment of the present invention.

The following process steps are detailed in Figure One:

Step 1: An applicant 1A uses a web client 1A1 to interact with an issuing bank's server 1D, ultimately choosing to apply for a new line of credit or to re-apply, re-enroll, or convert an existing line of credit, or other financial account, such as a debit, checking or savings account, for identity verification, added biometric security and convenience. An online credit or conversion application is provided. The applicant completes the application and returns personal and demographic information to the issuing financial institution's server 1D.

Step 2: The issuing financial institution's application software uses one or more credit servers (databases) 1E to assign a credit score to an applicant. If the score is not adequate, according to the specifications of the issuing financial institution that provides credit, the process stops. If the credit score is adequate, the financial institution's software assigns the applicant a biometrically protected credit account number that is transmitted to the biometric system for storage at a separate and secure database within the proprietary biometric system. This biometrically protected credit account number is valid for eCommerce transactions only if the remaining steps in the installation process are completed successfully. Furthermore, the financial institution's assigned biometrically protected credit account number is only valid for a biometric system's biometrically secured eCommerce transactions.

Step 3: The financial institution's software informs the biometric system that personal credit has been granted, so the applicant is now a registered buyer that must have their identity authenticated. A notification is presented to the applicant containing instructions for the next step in the enrollment process. The instructions also contain a link to the biometric system server 1F. The information further contains a link to the credit account to be assigned to the buyer on completion of the installation process.

Step 4: The buyer proceeds with the next step by contacting the biometric system process server 1F. The server interacts with the buyer to begin the process of authenticating the buyer's identity. This process involves asking the buyer a series of randomly generated “out of wallet” questions, which include but are not limited to questions that are not typically publicly known, such as previous street address, current street name, mortgage lender, mortgage loan payment amount, auto lender, auto loan payment amount, vehicle make, current market value of property, date home was built, student loan lender, student loan amount or any other questions that are known to the buyer but not generally known to the public for purposes of authenticating the buyer's identity online.

In another embodiment of the invention, a background check is performed on an applicant in order to verify the applicant's identity rather than use the previously described randomly generated questions. The biometric system process server receives an applicant's identifying information through a computer network from a client hosted by the buyer's computer system and generates a background query that checks several derogatory databases to confirm the identity of the applicant using the applicant's identifying information. For example, the data verification query may measure the length of time the applicant's information has been in use while also scoring key identity elements for consistency, such as confirming that a given Social Security Number (SSN) matches the applicant's address; the applicant's last name matches the last name associated with the given SSN; the individual associated with the SSN is not deceased; and that the SSN given by the applicant is unique. The server transmits the confidence score of the online applicant to the client through the computer network to verify the identity of the online applicant. The data verification score is sent through the computer network and authorizes the credit account by the server if the data verification score is at a level that is acceptable.

Step 5: The biometric system process server IF interacts with an identity authentication gateway 1G providing the gateway with the information collected from the buyer.

Step 5B: Optionally, the biometric system process server IF may interact directly with the Identity Authentication Server (1H).

Step 6: The identity authentication gateway 1G interacts with identity authentication server 1H to determine an identity score for the buyer. The score is returned to the biometric system process server 1F via the identity authentication gateway 1G. This represents the return leg of step 5.

Step 7: The biometric system process server 1F determines if the identity score is adequate, based on the financial institution partner's parameters, to authenticate the buyer's identity. If the score is not adequate, the process is repeatable based on the financial institution's requirements. If identity authentication does not occur, then the buyer cannot be approved online, and the identity authentication must be completed by call center or through regular mail. If the score is adequate, the buyer is allow to proceed to the next step, the installation of the biometric system payment system by the buyer's web client.

Step 8: The buyer interacts with the biometric system detection server 1B to register biometric templates.

The buyer's biometrically protected credit account number assigned in step 2 is made available to the detection server.

Step 8B: The biometric system detection server 1B forwards the collected biometric templates to a biometric clearinghouse server (1J) for storage. The detection server assigns a unique account number to the buyer, which is encrypted and stored at the buyer's computer system. The unique account number is invisible to the buyer and is only transmitted with a live biometric sample at time of purchase.

Step 9: Upon successful installation of the biometric system payment system and biometric template registration, the biometric system detection server 1B informs the financial institution server 1D the buyer's identity has been authenticated and the buyer is ready to use the biometric system. The buyer's biometrically protected credit account number from step 2 is confirmed by the biometric system and the financial institution Server 1D is signaled with a confirmation code from the detection server 1B in order to prove authentication of the buyer to the financial institution.

In a biometric system in accordance with an exemplary embodiment of the present invention, biometric samples may be extracted from various devices commonly found on standard computers, Personal Digital Assistants (PDAs), wireless devices, mobile phones and the like. The aforementioned devices can all be used to capture various types of biometric data. Examples include a computer keyboard 1A3 attached to a computer 1A and a standard microphone 1A4 that can also be used to acquire a buyer's biometric data. In addition, a digital camera 1A7 is also capable of acquiring a buyer's 1A facial features and/or eye biometric data. For the purpose and embodiment of the invention, buyers 1A will be prompted by the biometric system detection server 1B to select a biometric technology of choice. Buyers may also be asked to download the associated software to enable the existing device to be used to start the enrollment process.

Once approved, a credit account and credit line are established at financial institution 1D and linked to the biometric certificate through the biometric system detection server 1B. A biometric credit account may include fields for a credit account number, customer name, customer address and data about the sponsoring organization. Data recorded for the biometric certificate by the biometric system detection server 1B will include such sponsoring organization information and status information showing whether the customer has accepted the line of credit and whether the account has been authenticated and activated successfully.

Once buyer 1A accepts credit line, he or she is prompted to enroll their device of choice. These devices can either be a voice-scan 1A4 entered by microphone or keystroke-scan 1A3 entered by keyboard, or both. Enrollment grants immediate access to a small amount or all of their authorized credit line from issuing bank 1D, depending on the requirements of the financial institution. At this point, buyer 1A is setup to make use of the biometric system and perform biometrically secured purchases.

Buyer 1A is asked to select a biometric method and to download the appropriate software. Upon completion, buyer 1A is presented with a brief enrollment tutorial demonstrating enrollment procedures for voice-scans 1A4 and keystroke-scans 1A3. Pre-enrollment screens prompt buyer 1A to speak a pass-phrase or type a password to until the quality of the enrollment is sufficient.

Voice-scan 1A4 enrollment is based on the buyer 1A reciting a phrase repeatedly. The keystroke-scan 1A3 process may take slightly longer, depending on buyer's 1A selection of a username and password as well as typing ability. The enrollment takes place through interaction with the biometric system detection server 1B. Buyer 1A will then be asked to provide at least one biometric sample via a biometric input device that is connected to buyer's 1A computer 1A1 and/or wireless device 1A2 (such as a finger scanner 1A5, microphone 1A4, face scanner or eye scanner). All aforementioned devices can be incorporated directly into a computer-enabled device and can include any variety of biometric input described.

If buyer 1A does not have a finger scanner on his or her computer 1A1, a separate finger-scanning device may be shipped to the buyer 1A for additional accuracy and security protection. Upon receiving the biometric device, buyer 1A is instructed to register the device in order to complete a second enrollment process. This second biometric device will be linked to the account of record by first having the buyer submit their existing biometric identifier to access their credit line and biometric certificate. This process will be used to verify their identity before appending an additional biometric identifier (finger-scan template) to the biometric certificate.

In a biometric system in accordance with an exemplary embodiment of the present invention, the biometric system of the invention operates in 1:1 verification mode, as opposed to 1:Many identification methodology. This means that a unique ID, account number, is provided to the biometric system as a precondition of biometric verification.

In order to provide 1:1 functionality, a unique account number is created for association with the buyer's biometric information. The unique account number is made available on the buyer's computer 1A1 via the biometric system detection server. The unique account number is independent of issuing bank 1D credit information, but specific to the registration of a certain biometric identifier, which is converted by a proprietary algorithm into a biometric template. This allows buyer 1A the flexibility to install the software on more than one computer.

In one biometric system in accordance with an exemplary embodiment of the present invention, biometric templates 1A6 are utilized throughout the process. A biometric template 1A6 is a file that contains distinctive elements derived from biometric samples. Biometric templates may be smaller than biometric images or samples. Biometric templates may be 1/100th to 1/1000th the size of their corresponding biometric sample and can be encrypted and processed with very little computing power. Biometric template 1A6 is created at buyer's computer 1A1. The template creation takes place on the buyer's computer 1A1, a local machine, ensuring that no biometric samples are created outside the context of the biometric system.

In one embodiment of a biometric system in accordance with an exemplary embodiment of the present invention, once enrollment is successful, biometric template 1A6 is transmitted via Secure Socket Layer (SSL) and proprietary communications protocols from buyer 1A to biometric system detection server 1B for account completion.

In one embodiment of a biometric system in accordance with an exemplary embodiment of the present invention, additional non-biometric data is incorporated into the buyer's record at the biometric system detection server 1B before transmission to biometric system clearinghouse 1J. This ensures that a record, even if compromised in the clearinghouse 1J, is secure, as any compromised records would only be useful in conjunction with proprietary biometric system data. This data may include data/time stamp of record creation, and may also include biometric system private keys.

From here, biometric template 1A6, along with a buyer ID and proprietary biometric system data, are transmitted securely via SSL and a proprietary protocol to biometric system clearinghouse 1J. The buyer's record and identity credential are united and stored at the biometric system clearinghouse 1J as a biometric certificate for use in verifying future biometric system transactions. Biometric templates 1A6 are transmitted and stored in encrypted format and decrypted during the verification stages.

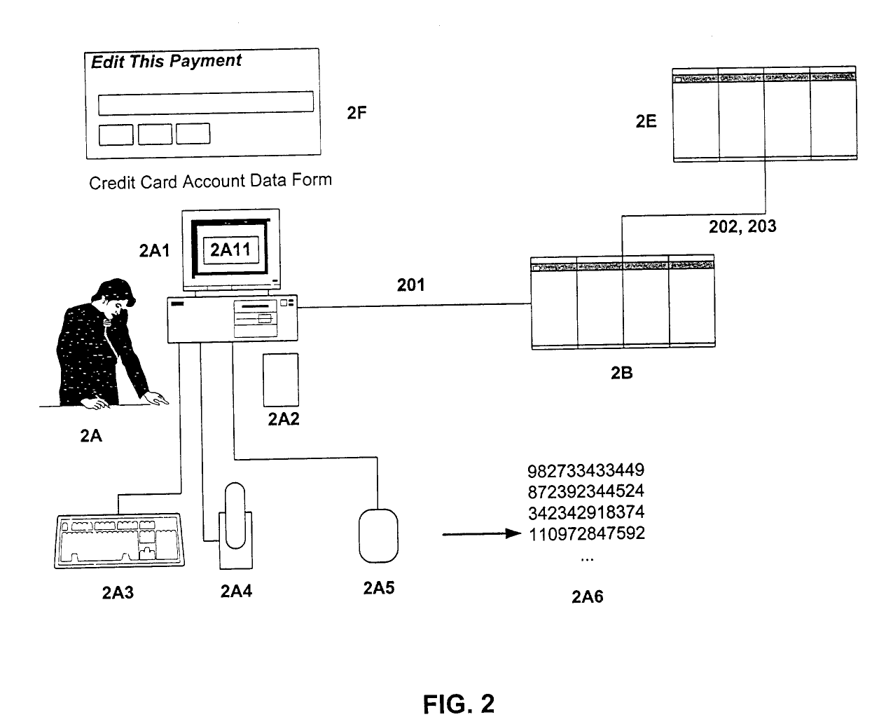

FIG. 2 is a diagram depicting an verification process flow as a buyer uses the invention to make a biometrically secured transaction in accordance with an exemplary embodiment of the present invention. The vast majority of a buyer's interactions with the biometric system will be in verification. A biometric verification interface is used at the time of purchase, when buyer 2A is prompted to enter credit information 2F on a typical online Merchant purchase web page. A biometric purchasing icon 2A11 or cookie interface is located either on an embedded HTML microportal digital assistant, located at the bottom of a computer screen, or in the system tray or on the web browser skin. The buyer can activate it with a hotkey, by clicking on an icon 2A11 in the system tray, or by simply placing a finger on a biometric device 2A5. Other devices can be used for biometric input, including a keyboard 2A3, a microphone 2A4, and the like. This icon 2A11 is front-end interface and is the trigger mechanism for transmitting data over a secure network 201 connection to a biometric system detection server 2B responsible for gathering and transmitting data 202 to be matched at the biometric clearinghouse 2E. Depending upon how a buyer 2A has configured his or her enrollment interface on his or her computer enabled device such as a PDA 2A2, personal information, such as name and shipping address, may be encrypted and transmitted 201 along with the biometric credit verification, or it may be filled in manually via the biometric system detection server 2B.

As during enrollment in FIG. 1, buyer 2A, is assigned a unique account code. This unique account number is used to help verify the buyer's identity. This unique set of identifiers may take the form of a cookie placed on the buyer's personal computer or otherwise secured on the buyer's computer 2A1. This identifying information will accompany the biometric template 2A6 transmitted 201 to detection server 2B. This step ensures accuracy and verification of account status prior to transmitting 202 to the biometric clearinghouse 2E for final biometric template authentication and verification.

The biometric sample is acquired from the biometric device and checked for quality. At this point, a template is generated through a unique mathematical algorithm on buyer's computer 2A1. The template 2A6, along with the user identification account code, are transmitted 201 to the biometric system detection server 2B via SSL and a proprietary communications protocol. From here, the template and ID information are routed 202 to the Biometric Clearinghouse 2E. The ID information is located, and the enrollment template is retrieved.

The two sets of data template 2A6 and buyer's specified ID information are compared to determine correlation. This takes place on clearinghouse server 2E and is the one point of the biometric process in which the underlying data is not encrypted. As there is no expectation of a 100% match, the Biometric Clearinghouse 2E must use a specific threshold to determine whether a sufficiently high-quality match has taken place.

The score necessary for a given transaction to be declared a match is determined by an algorithm generated through the biometric system detection server 2B prior to being transmitted via 202 to biometric clearinghouse 2E. This algorithm then balances the value and type of transaction with the purchase history of the buyer 2A. For high-risk, high-value transactions, a relatively high match score will be required and transmitted 202 from biometric system detection server 2B to Biometric Clearinghouse 2E, whereas a routine purchase could optionally be verified at a somewhat lower threshold. One of the invention's many competitive advantages is the ability to enforce higher levels of verification for specific transactions in a process invisible to the buyer 2A.

For example, a user with a history of sub-$100 transactions, when making another low-value transaction, can be considered a match through any verification attempt at or above 95% certainty. If the same user is purchasing an item for $500, the match may be required to return 99% certainty. Furthermore, if someone has attempted to access a user's account 2A unsuccessfully, the account's security threshold may be increased to reduce the likelihood of the account being breached. These adjustments can optionally take place on the fly as per the requirements of a financial institution, such that the threshold can be automatically set to immediately respond to certain transaction types. Note that these percentages do not represent the amount of data in common between an enrollment biometric template and a verification biometric template, but instead represent the likelihood that the match is correct. If the correlation does not meet the threshold, a “no match” message is transmitted to buyer's computer 2A1 from detection server 2B. Buyer 2A is generally allowed several attempts to verify, but this may be adjusted according to transaction type and buyer history.

If the degree of correlation between the two templates exceeds the transaction threshold, a “match” decision is transmitted to biometric system detection servers database 2B and back to the company's website.

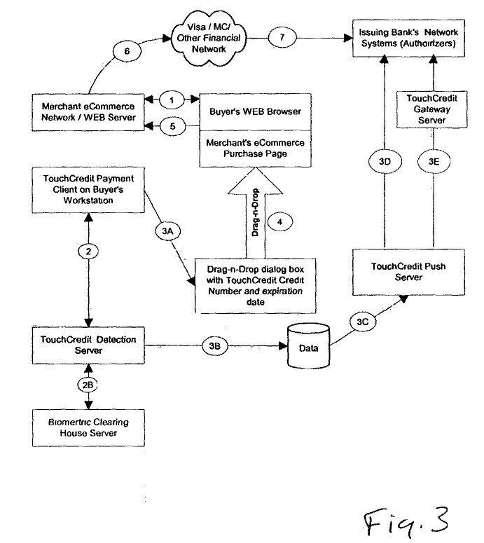

FIG. 3 is a diagram showing the inter-relationship of certain functional and operative computer systems and components consisting of a biometric clearing house, an issuing bank, a detection server, the payment network(s), and a merchant bank in accordance with an exemplary embodiment of the present invention. The biometric verification process, as described in FIG. 2, is only half of the transaction equation. The biometric system verifies, using its detection server's database, that the purchaser's account is that of an authenticated individual. This non-biometric process can be executed simultaneously with a clearinghouse-situated biometric comparison in order to minimize transaction-processing time.

Each step in FIG. 3 is explained below:

Step 1: The buyer visits an eCommerce Web site, prepares to make a purchase and loads the merchant's purchase page that calls for a credit card number and expiration date.

Step 2: The buyer interacts with the system web client to obtain a biometrically protected credit account number and expiration date. The interaction requires the buyer successfully negotiate a biometric login as well as supply a maximum dollar amount for the pending purchase.

Step 2B: The biometric login in step 2 requires interaction with the biometric clearinghouse server. The biometric template collected in step 2 is forwarded with the unique account number to the biometric clearinghouse for matching against a biometric template previously affixed to a biometric certificate.

Step 3A: The biometric system displays a dialog box containing the biometrically protected credit account number and expiration date.

Step 3B: The biometric system server records the buyer's request for an instance of the biometrically protected credit account number by writing transaction data into a biometric system database. The transaction data includes the buyer's biometrically protected credit account number, the expiration date, the expected maximum dollar amount for the transaction as well as the date and time the biometric verification was successful.

Steps 3C, 3D/3E below define the biometric system's TVC architecture. TVC is a process of moving the originating transaction information to the issuing bank's (as known as authorizers in this context) environment. The TVC is flexible, thereby minimizing the intrusion upon the existing authorizer's systems. The TVC architecture communication methodology used to move eCommerce transaction data from biometric systems to authorizer's systems may be further described as a push transaction system. The biometric systems servers simply push transaction data as a post on to waiting database servers within the authorizer's environment.

The TVC architecture defines the transaction data to be pushed into the authorizer's environment as a post to include, but not necessarily limited to, the following originating transaction information:

1. The exact date and time the transaction originated on the biometric system servers. This is the date and time the consumer requested the transmission of a biometrically protected credit account number from the biometric system server to the buyer's web client.

2. The biometrically protected credit account number.

3. The expiration date returned to the workstation with the biometric system credit account number.

4. The installation identification number (Install ID) assigned to the client side software installation.

5. The unique account number

6. The biometric system server identification number used to process the transaction.

7. The lifetime transaction count associated with the biometric system credit account number.

8. The maximum dollar amount for the transaction.

Step 3C: The biometric system push server reads the transaction database and prepares the transaction data for transmission to the financial institution's database servers.

Step 3D/3E: The biometric system push server pushes transaction data into an authorizer's database environment as a post.

In most cases, authorizers provide an environment to accept the incoming transactions. However, the biometric system provides an optional server (biometric system gateway server 3E), which resides outside an authorizer's network and accepts incoming transaction data from the biometric system (the biometric system's push server).

If the authorizer's accesses transaction data from the gateway server, the transaction data is stored directly in the authorizer's existing database systems is compared over a virtual private network to the transaction data on the gateway server. If the biometric system gateway server is used, the transaction data is stored in a biometric system database system accessible by the gateway server located outside the authorizer's local network.

In either case, the data is easily blended into existing authorizer's applications and business rules simply by accessing a database; within an authorizer's network or outside the authorizer's local network. If the authorizer chooses to provide the environment to catch the incoming transaction data, the biometric system push server may be custom coded to conform to authorizer's specifications so as to reside within their legacy network.

Step 4: The buyer populates the merchant's eCommerce purchase page with the supplied biometrically protected credit account number and expiration date.

Step 5: The buyer completes the transaction by submitting the merchant's eCommerce purchase page.

Step 6: The merchant's servers forward the transaction to a financial network as a standard transaction.

Step 7: The bank receives the transaction from the financial network for credit verification. The transaction data should be readily available in the bank database environment via step 3D/3E.

In one biometric system in accordance with an exemplary embodiment of the present invention, an applicant uses a computer system, such as a personal computer hosting a client such as a Web browser, coupled to a financial institution's server to apply for biometric credit. The applicant fills out a credit application form transmitted by the financial institution's server to the applicant's computer system and submits the form to the financial institution offering biometrically enabled credit. If the applicant's credit score is acceptable to the financial institution, then an issuing bank's servers contact a detection server to begin the previously described identity authentication process. The applicant answers a set of randomly generated questions generated from regulated data using the applicant's credit profile or unregulated data from public, proprietary, and private information databases by the detection server to authenticate the applicant's identity in real-time and online. Once approved for credit, and the applicant, now buyer, is authenticated, the system creates an identity credential file. The buyer is then asked to download a software biometric shopping assistant incorporating a Graphical User Interface(GUI) and an access icon to their computer system. A unique account number is assigned, encrypted, and stored in the buyer's computer system along with the downloaded software. The GUT or biometric shopping assistant icon exists as a visible connection to the biometric system and resides on a buyer's desktop in the system tray, in an Internet browser, or integrated into a web page. At this point, a buyer enrolls their biometric identifier for storage within the biometric system as previously described.

The GUT enables “one-click” access to online identity verification, payment, cross selling, as well as secure account management for buyers. This GUT also has a “fill in the form” option that automatically populates each field in any online personal information form. Additionally, the buyer has the ability to store their biometrically protected pins and passwords to gain immediate access to password protected web sites. The buyer clicks on the icon and invokes the shopping assistant GUI at anytime to facilitate biometrically secured payments that can be accepted at any etailer's web site. The entire biometric system is activated and facilitated through the GUI accessible from the biometric shopping assistant icon.

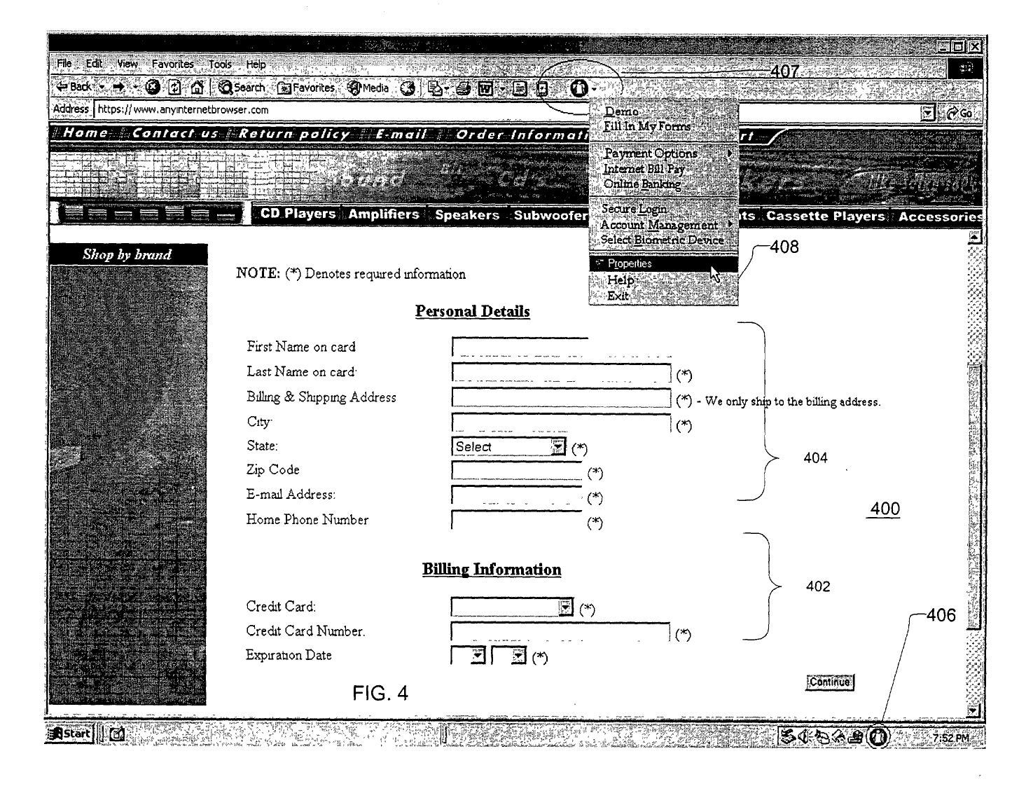

FIG. 4 is a depiction of a Web browser display with a biometric shopping assistant icon in accordance with an exemplary embodiment of the present invention. A Web browser display for a data entry form 400 for a retailer's Web site includes an area for entry of billing information 402 and an area for entry of personal data 404. A buyer using the retailer's data entry form may select a biometric shopping assistant icon 406 to invoke a biometric shopping assistant.

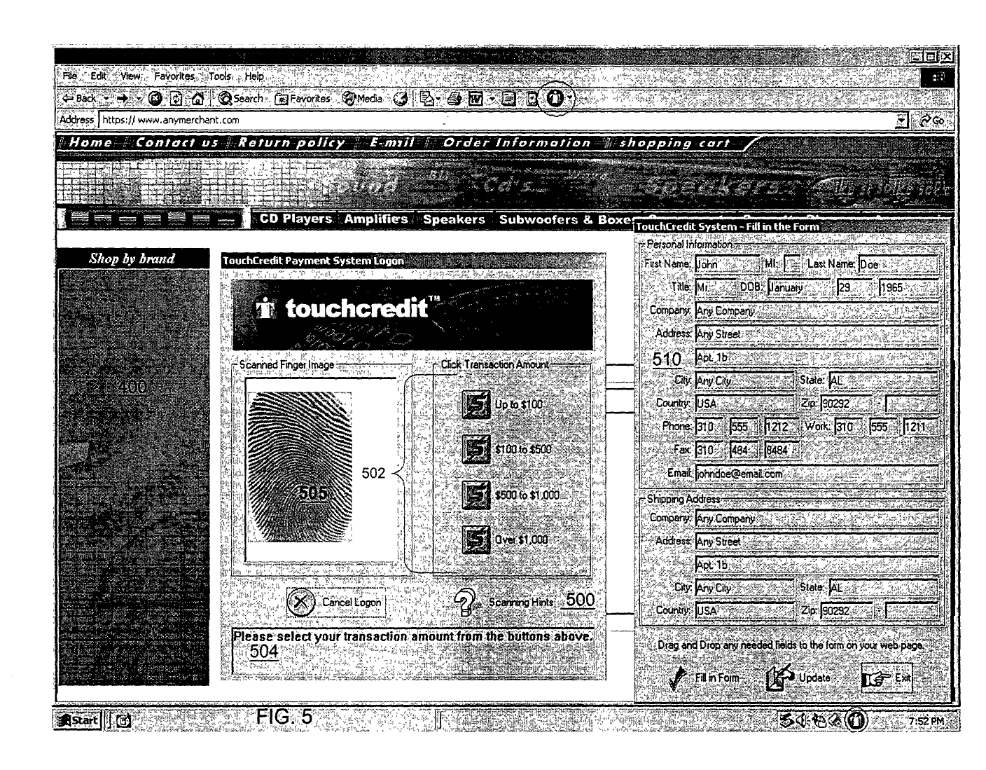

FIG. 5 is a depiction of a biometric shopping assistant graphical user interface in accordance with an exemplary embodiment of the present invention. A biometric shopping assistant graphical user interface includes a biometric sample collection screen 500 for collection of a biometric verification sample from the buyer. The biometric sample collection screen includes a set of radio buttons 502 for selection of a transaction value by the buyer. As previously described, the higher the transaction value, the more stringent the acceptance threshold will be set when comparing biometric templates. The buyer is given a prompt 504. In this embodiment of a biometric sample collection screen, the biometric scanning device is a fingerprint scanner for collection of a fingerprint 505.

The type of prompt given to the buyer is dependent on the type of biometric sample collection device the buyer is using. In another embodiment of a biometric sample collection screen, the prompt area displays a prompt suited to the type of biometric sample being collected. For example, if a face-scan is used, the buyer is prompted to say a pass phrase while being monitored by a video device. For other biometric samples, the buyer may be prompted to place a finger or thumb on a finger-scanning device or may be prompted to type or say a pass phrase. The prompt may be customized to match the type of scan used such as a facial-scan, a finger-scan, a hand-scan, an iris-scan, a keystroke-scan, a signature-scan, a voice-scan, a DNA-scan, or a retina-scan.

The biometric shopping assistant receives a verification biometric sample from the buyer and generates a verification biometric template using the sample as previously described. The biometric shopping assistant transmits the verification biometric template and the transaction value to a server where the verification biometric template is compared to a registration biometric template using the transaction value to determine an acceptance threshold as previously described. If the verification biometric template is verified, then the biometric shopping assistant receives buyer and credit account information that the biometric shopping assistant displays in a transaction information screen 510.

In one embodiment of a biometric shopping assistant in accordance with the present invention, the biometric shopping assistant populates data entry form 400 with the buyer and credit account information. In another embodiment, a buyer copies the buyer and credit account information from the transaction information screen into the data entry form.

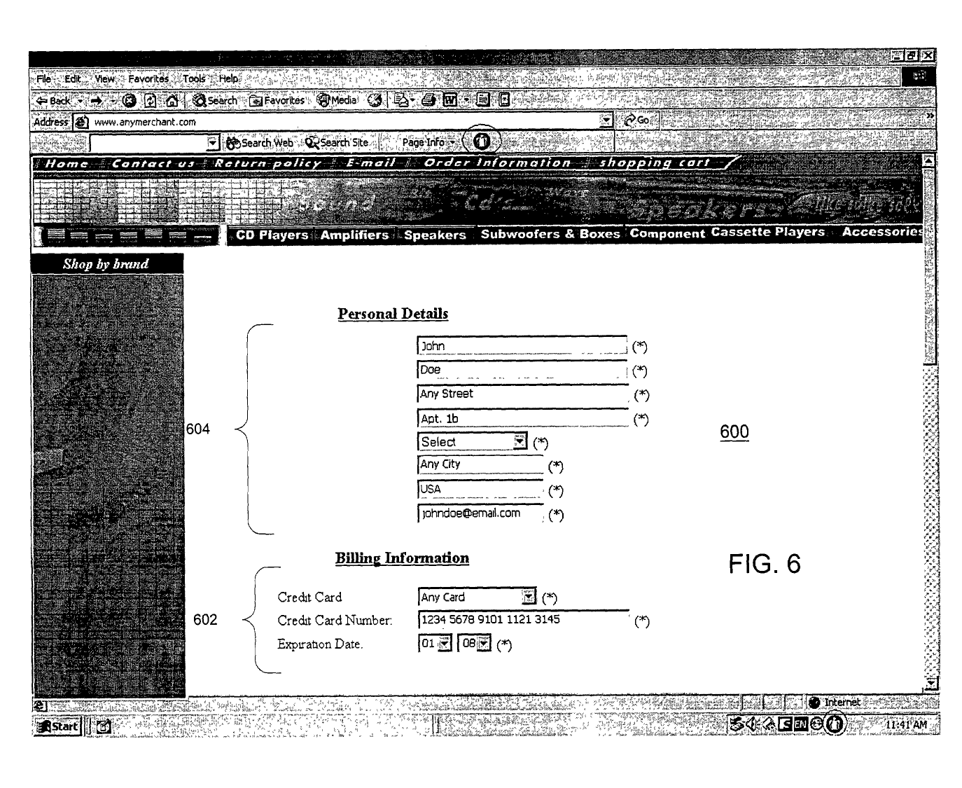

FIG. 6 is a depiction of a completed data entry form in accordance with an exemplary embodiment of the present invention. A data entry form 400 includes a billing information area 402 and an personal data entry area 404 as previously described. The completed data entry form includes buyer information from transaction screen 510 of FIG. 5.

Although this invention has been described in certain specific embodiments, many additional modifications and variations would be apparent to those skilled in the art. It is therefore to be understood that this invention may be practiced otherwise than as specifically described. In addition to the illustrative biometric system discussed herein, including any sponsoring organizations, financial institution(s), issuing bank(s), company(s) that issue credit lines or credit services, payment processors or biometric clearinghouse may be, for example, any organization or entity. Thus, the present embodiments of the invention should be considered in all respects as illustrative and not restrictive, the scope of the invention to be determined by any claims supportable by this application and the claims' equivalents.

What is claimed is:

1. A method of authorizing a financial transaction for a buyer over a computer network, comprising:
receiving a verification biometric sample by a client from the buyer;
generating a verification biometric template using the verification biometric sample by the client;
transmitting the verification biometric template by the client to a server through the computer network;
generating a match score between the verification biometric template and an enrollment biometric template by the server; and
authorizing the financial transaction by the server if the match score exceeds a threshold score.

2. The method of claim 1, further comprising:
receiving a transaction value by the client from the buyer;
transmitting the transaction value by the client to the server through the computer network; and
generating the threshold score by the server using the transaction value.

3. The method of claim 1, further comprising associating the verification biometric template with a time by the server.

4. The method of claim 3, wherein authorizing the financial transaction further includes using the time associated with the verification biometric template.

5. The method of claim 1, further comprising associating a system identifier with the verification biometric template by the client.

6. The method of claim 5, wherein authorizing the financial transaction further includes using the system identifier associated with the verification biometric template.

7. The method of claim 1, further comprising transmitting a credit account identifier by the server to the client through the computer network upon authorizing the financial transaction.

8. The method of claim 1 wherein the biometric sample is selected from the group consisting of a facial-scan, a finger-scan, a hand-scan, an iris-scan, a keystroke-scan, a signature-scan, a voice-scan, a DNA-scan and a retina-scan.

9. The method of claim 1 wherein the client is hosted by a device selected from the group consisting of a laptop computer, a desktop computer, a mobile telephone, and a personal digital assistant.

10. A method of opening a biometrically protected credit account by an applicant for use in a payment system over a computer network, comprising:
receiving by a server an applicant identifier from a client through the computer network;
generating a set of questions by the server using the applicant identifier;
transmitting the set of questions by the server to the client through the computer network;
receiving a set of answers corresponding to the set of questions by the server from the client through the computer network; and
authorizing the credit account by the server if the set of answers are correct with respect to the questions.

11. The method of claim 10, further comprising:
receiving a biometric sample by the client from the applicant;
generating a biometric template by the client using the biometric sample; and
transmitting the biometric template by the client to the server through the computer network.

12. The method of claim 11 wherein the biometric sample is selected from the group consisting of a facial-scan, a finger-scan, a hand-scan, an iris-scan, a keystroke-scan, a signature-scan, a voice-scan, a DNA-scan and a retina-scan.

13. The method of claim 10 wherein the client is hosted by a device selected from the group consisting of a laptop computer, a desktop computer, a mobile telephone, and a personal digital assistant.

14. An apparatus for authorizing a financial transaction for a buyer over a computer network, comprising:
means for receiving a verification biometric sample by a client from the buyer;
means for generating a verification biometric template using the verification biometric sample by the client;
means for transmitting the verification biometric template by the client to a server through the computer network;
means for generating a match score between the verification biometric template and an enrollment biometric template by the server; and
means for authorizing the financial transaction by the server if the match score exceeds a threshold score.

15. The apparatus of claim 14, further comprising:
means for receiving a transaction value by the client from the buyer;
means for transmitting the transaction value by the client to the server through the computer network; and
means for generating the threshold score by the server using the transaction value.

16. The apparatus of claim 14, further comprising associating a time with the verification biometric template by the server.

17. The apparatus of claim 16, wherein the means for authorizing the financial transaction further includes using the time associated with the verification biometric template.

18. The apparatus of claim 14, further comprising means for associating a system identifier with the verification biometric template by the client.

19. The apparatus of claim 18, wherein the means for authorizing the financial transaction further includes using the system identifier associated with the verification biometric template.

20. The apparatus of claim 14, further comprising means for transmitting a credit account identifier by the server to the client through the computer network upon authorizing the financial transaction.

21. The apparatus of claim 14 wherein the biometric sample is selected from the group consisting of a facial-scan, a finger-scan, a hand-scan, an iris-scan, a keystroke-scan, a signature-scan, a voice-scan, a DNA-scan and a retina-scan.

22. The apparatus of claim 14 wherein the client is hosted by a device selected from the group consisting of a laptop computer, a desktop computer, a mobile telephone, and a personal digital assistant.

23. An apparatus for opening a credit account by an applicant for use in a biometric payment system over a computer network, comprising:
means for receiving by a server an applicant identifier from a client through the computer network;
means for generating a set of questions by the server using the applicant identifier;
means for transmitting the set of questions by the server to the client through the computer network;
means for receiving a set of answers corresponding to the set of questions by the server from the client through the computer network; and
means for authorizing the credit account by the server if the set of answers are correct with respect to the questions.

24. The apparatus of claim 23, further comprising:
means for receiving a biometric sample by the client from the applicant;
means for generating a biometric template by the client using the biometric sample; and
means for transmitting the biometric template by the client to the server through the computer network.

25. The apparatus of claim 24 wherein the biometric sample is selected from the group consisting of a facial-scan, a finger-scan, a hand-scan, an iris-scan, a keystroke-scan, a signature-scan, a voice-scan, a DNA-scan and a retina-scan.

26. The apparatus of claim 23 wherein the client is hosted by a device selected from the group consisting of a laptop computer, a desktop computer, a mobile telephone, and a personal digital assistant.

27. A user interface for a biometric shopping assistant, comprising:
a selectable icon for invoking the biometric shopping assistant;
a biometric sample collection screen for capturing a biometric sample from a buyer by the biometric shopping assistant; and
a transaction information screen for display of buyer account information by the biometric shopping assistant.

28. The user interface of claim 27, wherein the biometric sample collection screen includes a prompt area for display of a prompt by the biometric shopping assistant.

29. The user interface of claim 27, wherein the biometric sample collection screen includes selectable transaction values.

30. A method of opening a biometrically protected credit account by an applicant for use in a payment system over a computer network, comprising:
receiving by a server applicant information from a client through the computer network;
generating a background check of the applicant by the server using the applicant information; and
performing the following if the server verifies the identity of the applicant using the applicant information and the background check:
authorizing the credit account by the server;
receiving a biometric sample by the client from the applicant;
generating a biometric template by the client using the biometric sample; and
transmitting the biometric template by the client to the server through the computer network.

31. The method of claim 30 wherein the biometric sample is selected from the group consisting of a facial-scan, a finger-scan, a hand-scan, an iris-scan, a keystroke-scan, a signature-scan, a voice-scan, a DNA-scan and a retina-scan.

32. An apparatus for opening a biometrically protected credit account by an applicant for use in a payment system over a computer network, comprising:
means for receiving applicant information from a client through the computer network;
means for generating a background check of the applicant using the applicant information; and
means for authorizing the credit account if the identity of the applicant is verified using the applicant information and the background check; and
means for receiving a biometric template generated by the client using a biometric sample collected from the applicant.

33. The apparatus of claim 32 wherein the biometric sample is selected from the group consisting of a facial-scan, a finger-scan, a hand-scan, an iris-scan, a keystroke-scan, a signature-scan, a voice-scan, a DNA-scan and a retina-scan.
